(19) United States
(12) Patent Application Publication
(10) Pub. No.: US 2003/0174658 A1
(43) Pub. Date: Sep. 18, 2003

(54) Wireless multiplexing computer network system

(76) Inventor: John Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/096,923

(22) Filed: Mar. 14, 2002

(51) Int. Cl. H04B 7/00; H04Q 7/00

(52) U.S. Cl. 370/277; 370/314

(57) ABSTRACT

A wireless multiplexing computer network system includes a central receiver and a number of transmitters coupled to the central receiver in a wireless manner. The central receiver is connected to a host computer and selectively peripheral device. Each transmitter transmits a wireless transmission signal to the central receiver. The wireless transmission signal includes a security identification code for preventing transmission data error and suppressing noise, a classification identification code for determining if the signal is eventually transmitted to the peripheral device or the host computer, a function identification code for identifying the function or operation to be executed in the host computer or the peripheral device and a source identification code for identifying the particular transmitter from which the transmission is made. Based on the wireless transmission signals, the central receiver is capable to handle the transmissions from the transmitters in a multiplexing manner without interference occurring between the transmitters.

### BACKGROUND OF THE INVENTION

1. Field of the Invention

The present invention generally relates to a computer network system, and in particular to a wireless multiplexing computer network capable to receive and handle a plurality of inputs from a plurality of wireless transmitters.

2. The Related Art

Computer networking devices that are currently available in the market are generally of one to three wireless input devices, including a wireless keyboard, a wireless mouse and a remote control, and a single receiver for receiving data from the wireless input devices and transmitting the data received to a host computer. In operation, the wireless keyboard, the wireless mouse and the remote control work in different, independent channels. This is a feasible solution for a single computer based system. However, in case that a number of users are attempting to access a particular application program of the computer at the same time, interference caused by using the same frequency may occur between different wireless peripheral devices. In this respect, each user must b operating an independent computer in order to alleviate the frequency interference problem. A requirement for networking between the independent computers arises for data transfer between the computers. This complicates the overall configuration of the networking system and increases costs Further, it is sometimes difficult to put all the people accessing and using the computer networking system together at the same location.

For example, in a computer network based public tender with a number of bidders, each bidder must have an individual computer. A host computer networks the individual computers of the bidders together. Information or data are transferred from each individual computer to the host computer to be processed thereby. This slows down data transfer and processing. Further, in cases of malfunction of the computer of a single bidder, the whole computer network is affected.

### SUMMARY OF THE INVENTION

Accordingly, an object of the present invention is to provide a wireless multiplexing computer network system comprising at least two transmitters cooperating with a single central receivers coupled to a host computer whereby the transmitters are each assigned to individual users for allowing the plurality of users to access the host computer at the same time and operate the same application program.

Another object of the present invention is to provide a wireless multiplexing computer network system which allows a number of users to access the same host computer at the same time and requiring no cables connected between the host computer and the user's devices for simplifying the overall configuration and reducing costs thereof.

A further object of the present invention is to provide a wireless multiplexing computer network system comprising a number of transmitters communicating with a single receiver in a wireless manner, each transmitter transmitting to the signal receiver a wireless transmission signal including a security identification code for preventing transmission data error and suppressing noises, a classification identification code for identifying the destination of the data transmitted, a function identification code for identifying the function required to be executed in the host computer and a source identification code for identifying each individual transmitter whereby interference between the transmitters is eliminated.

To achieve the above objects, in accordance with the present invention, there is provided a wireless multiplexing computer network system comprising a central receiver and a number of transmitters coupled to the central receiver in a wireless manner. The central receiver is connected to a host computer and selectively peripheral device. Each transmitter transmits a wireless transmission signal to the central receiver. The wireless transmission signal includes a security identification code for preventing transmission data error and suppressing noise, a classification identification code for determining if the signal is eventually transmitted to the peripheral device or the host computer, a function identification code for identifying the function or operation to be executed in the host computer or the peripheral device and a source identification code for identifying the particular transmitter from which the transmission is made. Based on the wireless transmission signals, the central receiver is capable to handle the transmissions from the transmitters in a multiplexing manner without interference occurring between the transmitters.

### BRIEF DESCRIPTION OF THE DRAWINGS

The present invention will be apparent to those skilled in the art by reading the following description of a preferred embodiment thereof, with reference to the attached drawings, in which:

FIG. 1 is a system block diagram of a wireless multiplexing computer network system constructed in accordance with the present invention;

FIG. 2 is a flow chart of wireless communication between a transmitter and a central receiver of the wireless multiplexing computer network system of the present invention; and

FIG. 3 is a flow chart of data transfer between the central receiver and a host computer or a peripheral device in accordance with the present invention.

### DETAILED DESCRIPTION OF THE PREFERRED EMBODIMENT

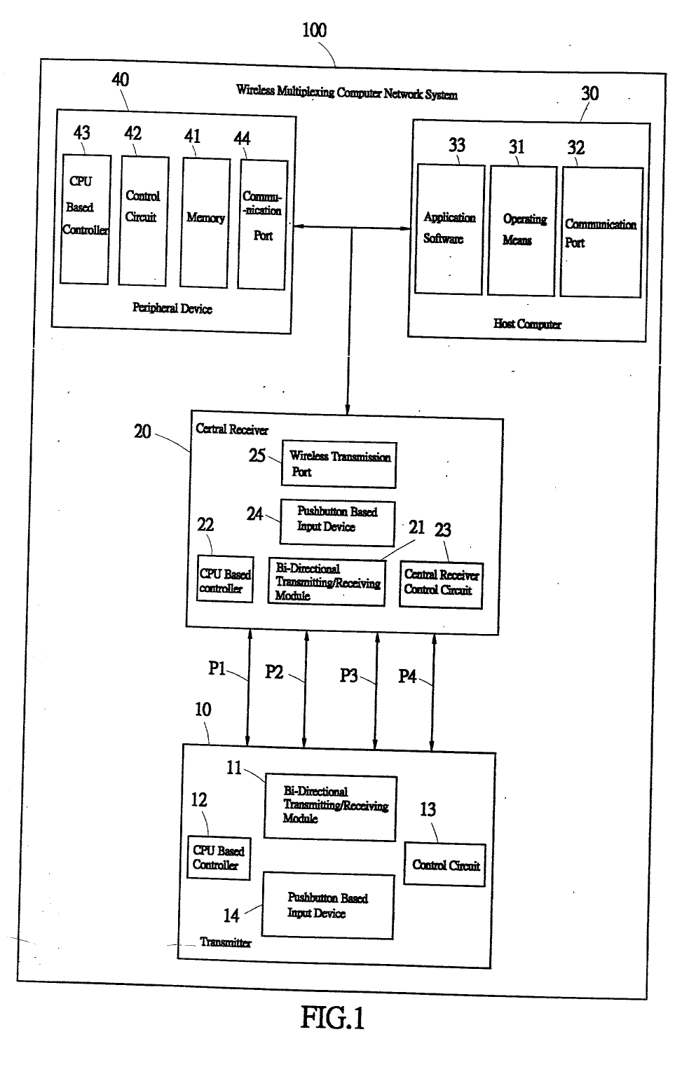

With reference to the drawings and in particular to FIG. 1, a wireless multiplexing computer network system constructed in accordance with the present invention, generally designated with reference numeral 100, comprises at least two transmitters 10 (only one being shown in the drawings for simplicity), a central receiver 20, a host computer 30 and a peripheral device 40. The transmitters 10 can be of any type embodied in any forms, such as a wireless keyboard, a wireless mouse or a remote control. Each transmitter 10 comprises a bi-directional wireless transmitting/receiving module 11, at least a central processing unit (CPU) based controller 12, a control circuit 13 and a pushbutton based input device 14 for entering data to be transmitted, application software required to execute and/or operation function requested. The data are transferred via a wireless transmission signal P transmitted by each individual transmitter 10 to the central receiver 20. The central receiver 20 receives and processes the wireless transmission signal P. The wireless transmission signal P is analyzed and data and codes are selectively transferred to the host computer 30 and/or the peripheral device 40 by means of connection formed by communication ports of the central receiver 20 and the host computer 30 and the peripheral device 40.

The wireless transmission signal P that is transmitted from each transmitter 10 includes:

(1) Security identification code P1: The security identification code P1 is to prevent data error during transmission between the particular transmitter 10 and the central receiver 20 and to suppress noise occurring in the wireless transmission between the transmitter 10 and the central receiver 20;

(2) Classification identification code P2: The classification identification code P2 identifies the destination of the transmitted data that is received by the central receiver 20 whereby the data is selectively transferred to the host computer 30 or the peripheral device 40 in accordance the classification identification code P2;

(3) Function identification code P3: The function identification code P3 identifies the function to be performed by the application software of the host compute 30 and/or the peripheral device 40; and

(4) Source identification code P4: The source identification code P4 identifies the particular transmitter 10 from which the data received by the central receiver 20 is transmitted.

The central receiver 20 comprises a bi-directional transmitting/receiving module 2, a CPU based controller 22, at least a central receiver control circuit 23, a pushbutton based input device 24 and a wireless transmission port 25 for receiving the wireless transmission signals P from the transmitters 10 in a multiplexing manner.

The host computer 30 comprises operating means 31 for user operating the host computer 30. Application software 33 is preloaded in the host computer 30 to be operated by the user via the operating means 31. The host computer 30 comprises a communication port 32, such as RS232, PS2, USB and IEEE 1394 port. Another example of the communication port 32 is a wireless communication port, such as IrDA and bluetooth port. The communication port 32 is connected to the central receiver 20 for receiving the signals P transmitted from the transmitters 10. The requirement contained in the signals P is then performed by the host computer 30.

The peripheral device 40 is a microprocessor based device, such as a programmable logic control (PLC). The peripheral device 40 comprises a CPU based controller 41, a control circuit 42, a memory 43 and a communication port 44. The memory 43 stores the application software and/or operating function to allow the peripheral device 40 to receive data from the receiver 20.

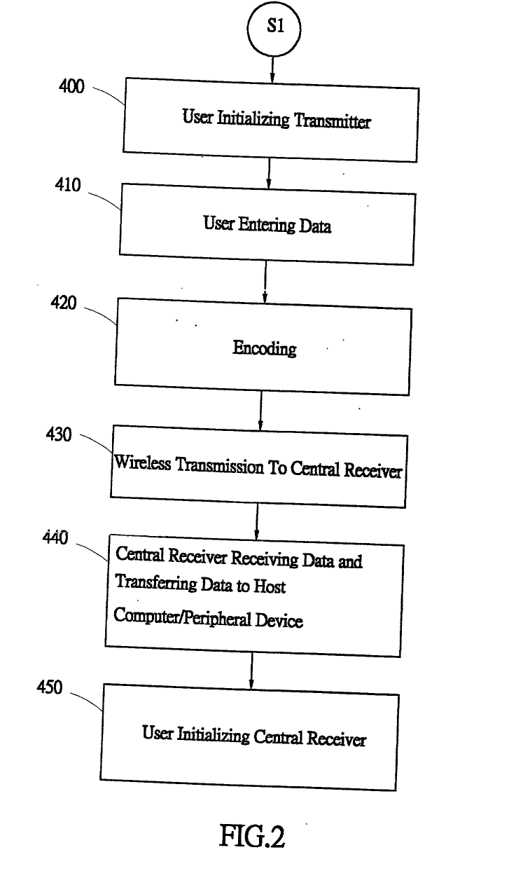

Referring to FIG. 2, the communication operation between the transmitter 10 and the central receiver 20 includes the following steps that are designated with reference numerals 400-450 in the drawings:

Step 400: A user initializes the transmitter 10 by means of the pushbutton based input device 14 of the transmitter 10;

Step 410: The user enters data by means of the pushbutton based input device 14 of the transmitter 10;

Step 420: The data input into the transmitter 10 is encoded by firmware to include basic data entered by the pushbuttons, the security identification code P1, the classification identification code P2 and function identification code P3;

Step 430: The data entered into the transmitter 10 is transmitted to the central receiver 20 in the form of the wireless transmission signal

Step 440: The central receiver 20 receives the transmitted data of the wireless transmission signal P and the data is decoded and analyzed whereby the data is selectively transferred to the host computer 30 or the peripheral device 40 based on the classification identification code P2; and

Step 450: The user initializes the central receiver 20 by means of the pushbutton based input device 24 of the central receiver 20.

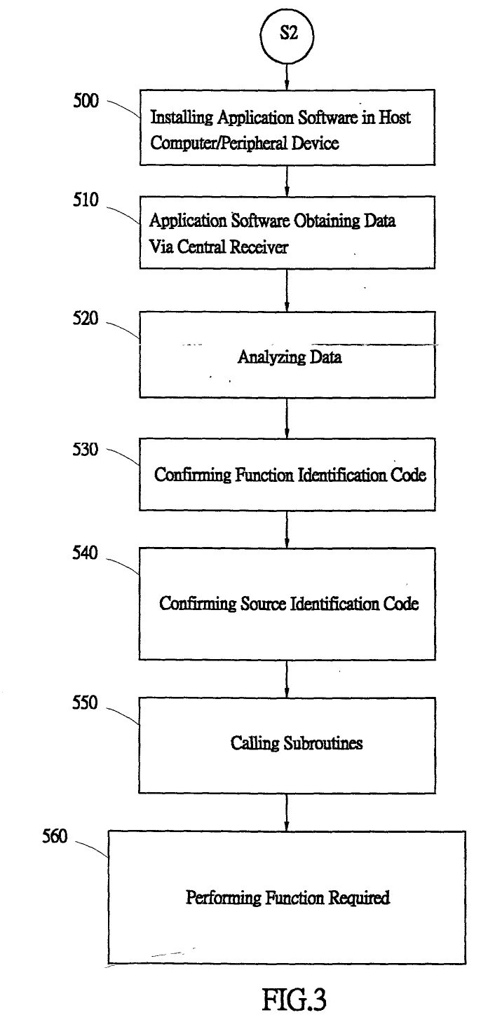

Referring to FIG. 3, data transferring operation between the central receiver 20 and the host computer 30 or the peripheral device 40 includes the following steps 500-560:

Step 500: A user installs application software in the host computer 30 or the peripheral device 40;

Step 510: The application software obtained data entered into the transmitter via the communication ports connected between the central receiver 20 and the host computer 30 or the peripheral device 40;

Step 520: The application software analyzes and confirms if the data entered by the user is compliant to the required format and structure;

Step 530: The application software further recognizes the function identification code P3 contained in the data to identify the function to be performed;

Step 540: The application software further recognizes the source identification code P4 to identify which transmitter 10 the data is transmitted from;

Step 550: The application software calls the subroutines associated with the function required to be performed; and

Step 560: Based on the functions of the application software, data entered by a number of users control the operation of the application software simultaneously, alternatively data from a single user controls the operations of different application programs or alternatively, a number of users control a number of different application programs at the same time.

To this point, it is understood that the wireless multiplexing computer network system 100 of the present invention eliminates the drawbacks of the conventional wireless systems and provides a useful means for industrial application. For example, in a public tender with 10 bidders, the wireless multiplexing computer network system 100 requires ten (10) sets of transmitters 10 cooperating with a single central receiver 20 coupled to a host computer 30 and/or a peripheral device 40. No wiring is required between the transmitters 10 and the central receiver 20 and no connection between the transmitters 10 is needed. Thus, the bidders do not need to be separated and can make their bids for the tender on the same site via the same host computer 30 and/or peripheral device 40. Costs of wiring and equipment installation are thus substantially cut off.

The major feature of the wireless multiplexing computer network system 100 of the present invention comprises a single central receiver 20 cooperating a number of transmitters in a wireless manner. A host computer 30 and selectively a peripheral device 40 are coupled to the single receiver 20. Each transmitter 10 transmits a distinct wireless transmission signal P including, besides the data to be transferred, a security identification code P1, a classification identification code P2, a function identification code P3 and a source identification code P4 for identifying the particular transmission between the particular transmitter and the receiver. Interference between the transmitters 10 is thus eliminated.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A wireless multiplexing computer network system comprising:
at least two transmitters each independently transmitting a wireless transmission signal comprising basic data to be transferred, a security identification code, a classification identification code, a function identification code and a source identification code for respectively preventing transmission data error and suppressing noises, identifying destination of the wireless transmission signal, identifying function and application software to be operated, identifying the transmitter from which the signal is transmitted;
a central receiver receiving the signals from the transmitters in a multiplexing manner and transferring the received data to a communication port of the central receiver;
a host computer coupled to communication port for receiving the signals from the central receiver via the communication port for performing function required by the signals; and
a peripheral device selectively coupled to the communication port for receiving the signals from the central receiver via the communication port for performing function required by the signals wherein the signals are selectively transferred to either the host computer or the peripheral device based on the classification identification code.

2. The wireless multiplexing computer network system as claimed in claim 1, wherein the transmitters are embodied in the forms selected from the group comprising a wireless keyboard, a wireless mouse and a remote control.

3. The wireless multiplexing computer network system as claimed in claim 1, wherein each transmitter comprises a bi-directional transmitting/receiving module, a central processing unit based controller, a control circuit and a pushbutton based input device.

4. The wireless multiplexing computer network system as claimed in claim 1, wherein the central receiver comprises a bi-directional transmitting/receiving module, a central processing unit based controller, a central receiver control circuit, a pushbutton based input device and a wireless transmission port.

5. The wireless multiplexing computer network system as claimed in claim 1, wherein the host computer comprises a communication port coupled to the communication port of the central receiver.

6. The wireless multiplexing computer network system as claimed in claim 1, wherein the peripheral device comprises a central processing unit based controller, a control circuit, a memory, a communication port selectively coupled to the communication port of the central receiver.
